(19) United States
(12) Patent Application Publication
(10) Pub. No.: US 2013/0016139 A1
(43) Pub. Date: Jan. 17, 2013

(54) LIGHT SOURCE UNIT AND IMAGE DISPLAY DEVICE

(71) Applicants: Mizuho Tomiyama, Tokyo (JP); Ryuichi Katayama, Tokyo (JP)

(72) Inventors: Mizuho Tomiyama, Tokyo (JP); Ryuichi Katayama, Tokyo (JP)

(73) Assignee: NEC CORPORATION, Tokyo (JP)

(21) Appl. No.: 13/637,687

(22) PCT Filed: May 12, 2011
(86) PCT No.: PCT/JP2011/060906

§ 371 Date: Sep. 27, 2012

(30) Foreign Application Priority Data
May 21, 2010 (JP) 2010-117241

(51) Int. Cl. F21V 9/14; G09G 5/10

(52) U.S. Cl. 345/690; 362/19

(57) ABSTRACT

Provided is a light source unit that can solve a problem, namely, the inability to emit polarized light having high directivity. Active layer 12B generates light. Reflective layer 11 reflects the light from active layer 12B. Opening array layer 13 is formed on a side opposite reflective layer 11 with respect to active layer 12B. Opening array layer 13 includes mirror unit 13A that reflects the light from active layer 12B, and opening 13B that transmits a polarized light component of a predetermined polarizing direction included in the light and reflects a polarized light component orthogonal to the predetermined light direction. Angle conversion unit 14 converts the traveling direction of the light transmitted through opening 13B.

### TECHNICAL FIELD

The present invention relates to a light source unit and an image display device.

### BACKGROUND ART

A projector normally modulates light emitted from the light source unit by using a spatial light modulation element to project the light to a screen.

When a light emitting diode (LED) or an organic electro-luminescence (EL) is used as the light source unit, normally, an emission intensity distribution of light emitted from the light source unit is a lambert distribution. The lambert distribution is an emission intensity distribution where the distribution of emission intensity with respect to an observation angle is proportional to the cosine of the observation angle. In the light emitted from the light source unit, an angular component emitted at an angle equal to or larger than a predetermined angle is lost without being entered into the spatial light modulation element. Concerning the projector, to achieve higher use efficiency of the light emitted from the light source unit than the lambert distribution, there is a demand for a light source unit having high directivity.

For the spatial light modulation element, normally, an element having polarization dependence such as a liquid crystal light valve (LV) is used. In this case, a polarized light component orthogonal to a predetermined polarizing direction, which is included in the light emitted from the light source unit, is lost without being modulated by the spatial light modulation element. Thus, concerning the projector, there is a demand for a light source unit that emits polarized light to achieve high use efficiency of the light emitted from the light source unit.

Patent Literature 1 discloses a light source device having high directivity. This light source device includes a solid light emitting element that includes a first electrode and a second electrode for supplying current to a light emitting unit, and an angle conversion unit that converts the angle of light emitted from the solid light emitting element.

The first electrode reflects light emitted from the light emitting unit toward the second electrode. The second electrode includes an opening through which the light from the light emitting unit exits. The angle conversion unit executes angle conversion to guide the light output through the opening in a predetermined direction, and outputs the light. Thus, since the light from the light source device is output in the predetermined direction, the directivity of the light emitted from the light source device is high.

Patent Literature 2 discloses a light emitting element that emits polarized light. This light emitting element includes a light emitting unit disposed on a reference plane, and an optical structure disposed on the exit side of the light emitting element. The structure includes a reflective polarization plate that transmits polarized light of a first vibration direction and reflects polarized light of a second vibration direction roughly orthogonal to the polarized light of the first vibration direction, and an optical unit formed to transmit the light from the reflective polarization plate and having a refractive index cyclically changed in a two-dimensional direction roughly parallel to the reference plane.

The light emitting element disclosed in Patent Literature 2 can efficiently convert the output light into polarized light by converting the polarized light of the second vibration direction reflected by the reflective polarization plate and then entering the light into the reflective polarization plate again. Further, the inclusion of the optical unit enables increase of external extraction efficiency of the light from the light emitting unit.

### CITATION LIST

### Patent Literature

Patent Literature 1: JP2006-165423A

Patent Literature 2: JP2007-109689A

### SUMMARY OF INVENTION

### Problems to be Solved by Invention

In the case of the solid light emitting element described in Patent Literature 1, while the output light has high directivity, the output light is not polarized, namely, it is unpolarized light. On the other hand, in the case of the light emitting element described in Patent Literature 2, while the output light can be polarized light, the output light has low directivity. As a result, the inventions described in Patent Literatures 1 and 2 have a problem, namely, the inability to emit polarized light having high directivity.

It is therefore an object of the present invention to provide a light source unit that can solve the problem, namely, the inability to emit polarized light having high directivity, and an image display device that uses the light source unit.

### Solution to Problem

A light source unit according to the present invention includes: a light emitting layer that generates light; a reflective layer that reflects the light generated from the light emitting layer; an opening array layer that is formed on a side opposite the reflective layer with respect to the light emitting layer and that includes a mirror unit configured to reflect the light generated from the light emitting layer, and a plurality of openings configured to transmit a polarized light component of a predetermined polarizing direction included in the light generated from the light emitting layer and to reflect a polarized light component orthogonal to the predetermined polarizing direction; and a direction conversion unit that converts the traveling direction of the light transmitted through the openings.

An image display device according to the present invention includes: the light source unit; and a display unit that modulates light emitted from the light source unit according to a video signal, and displays an image according to the video signal.

### Effects of Invention

According to the present invention, polarized light having high directivity can be emitted.

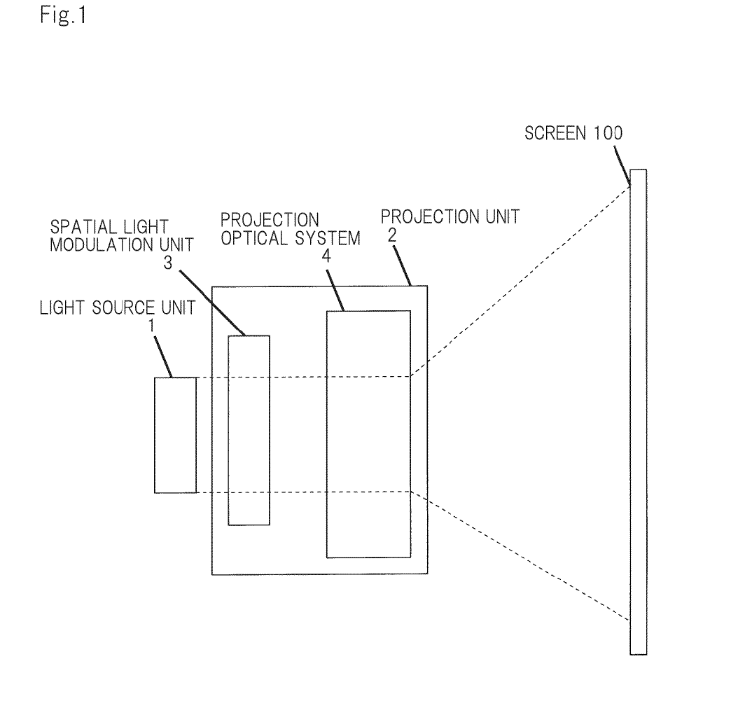

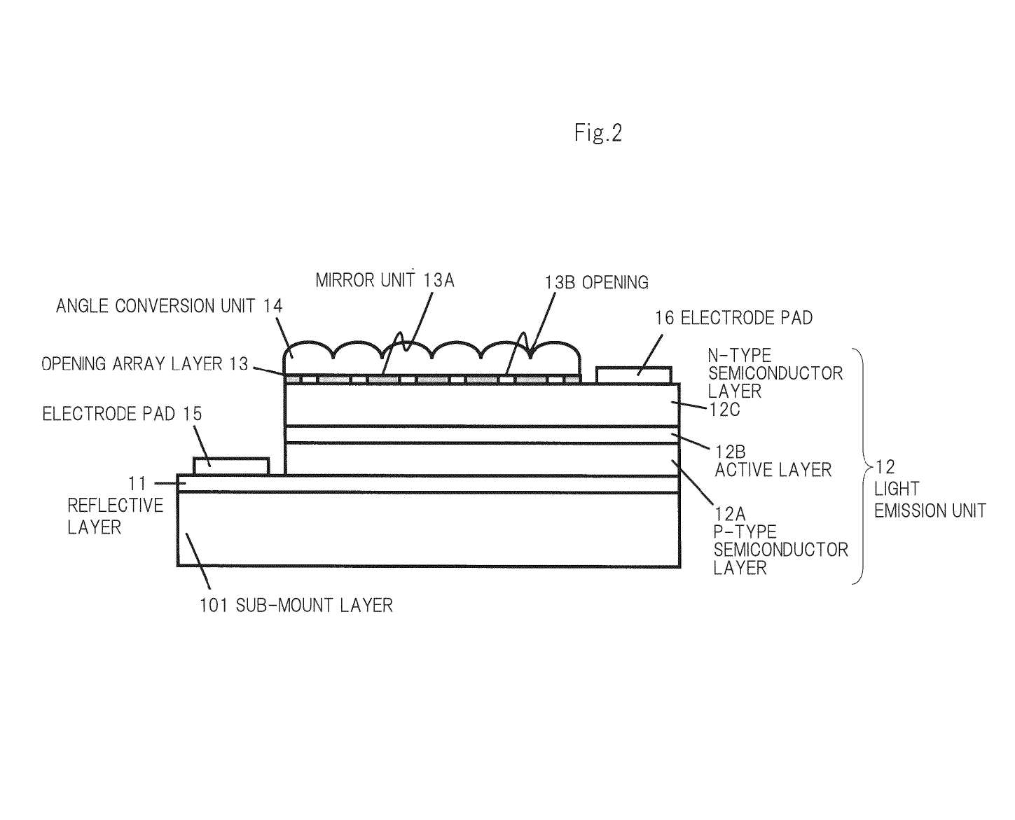

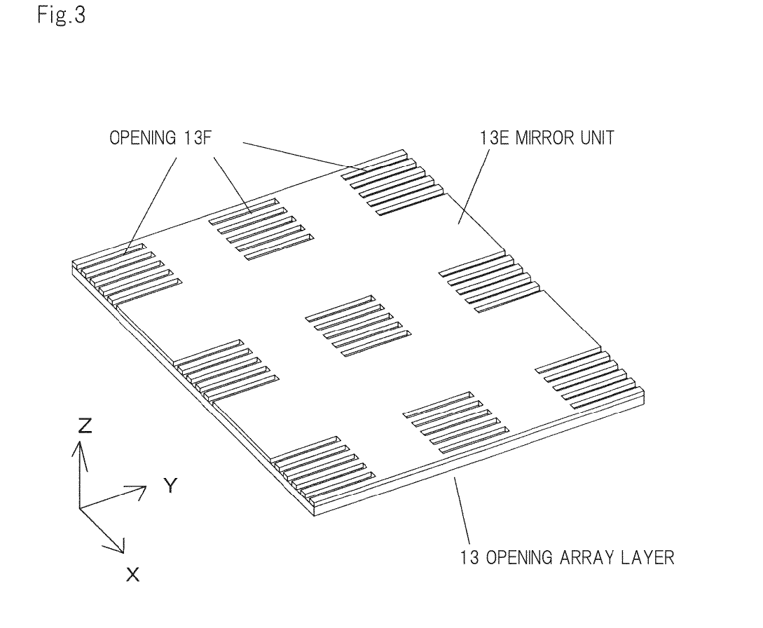

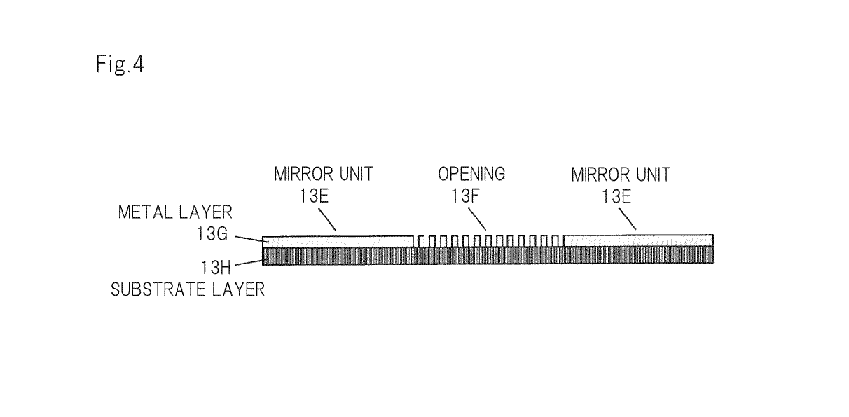

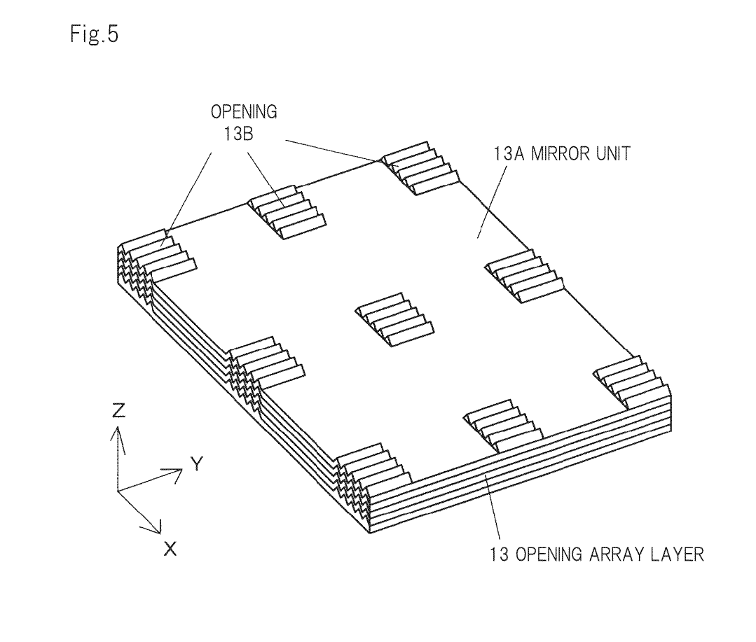

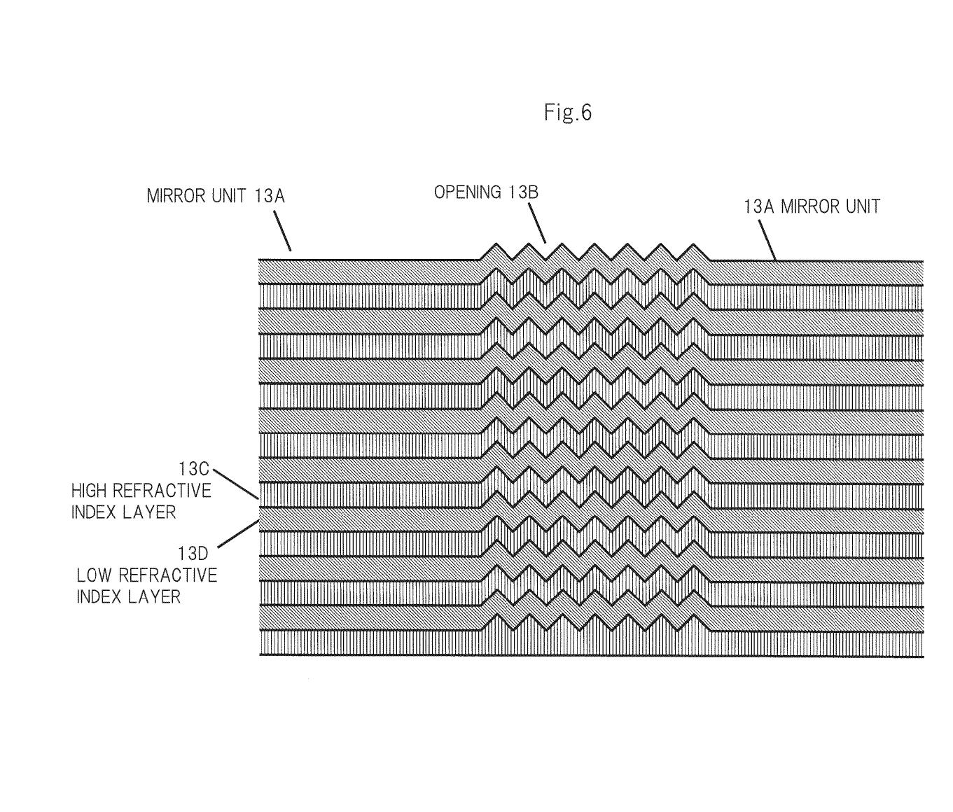

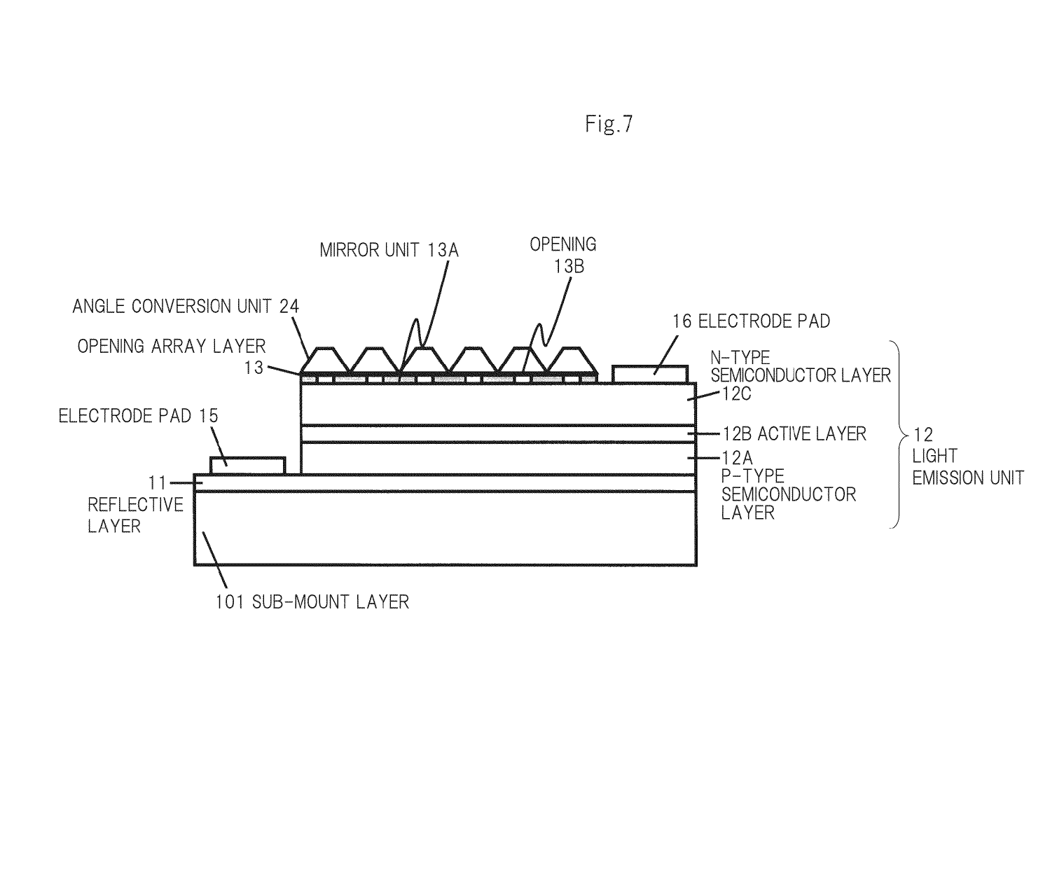

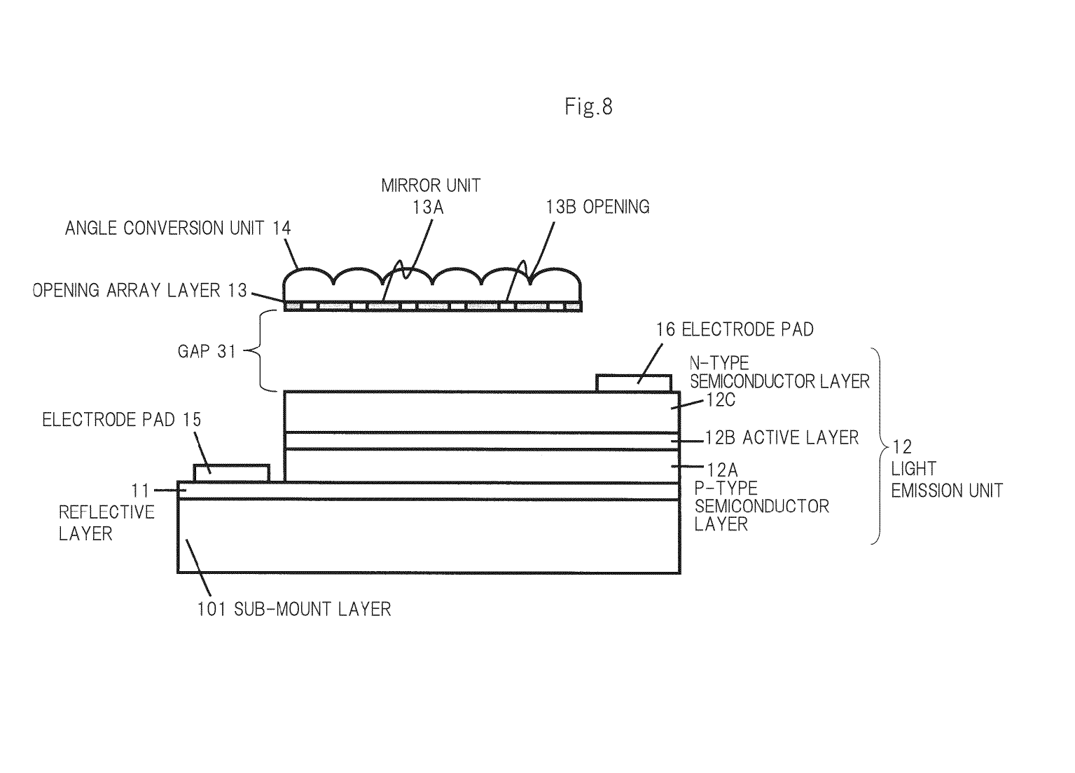

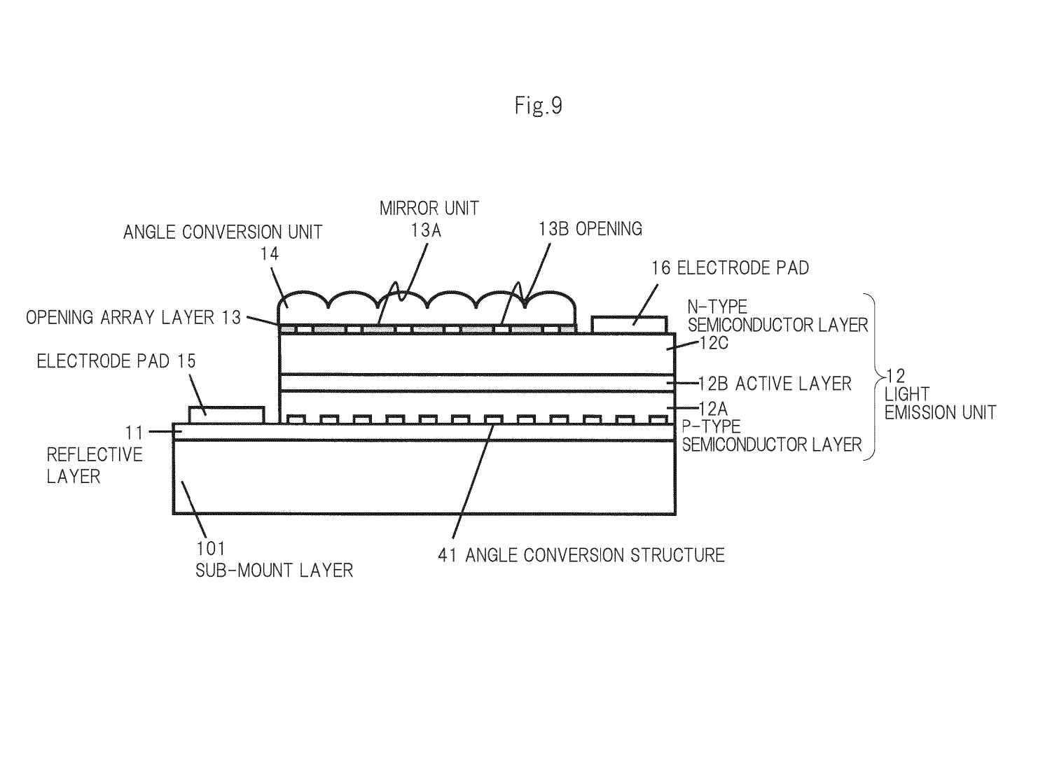

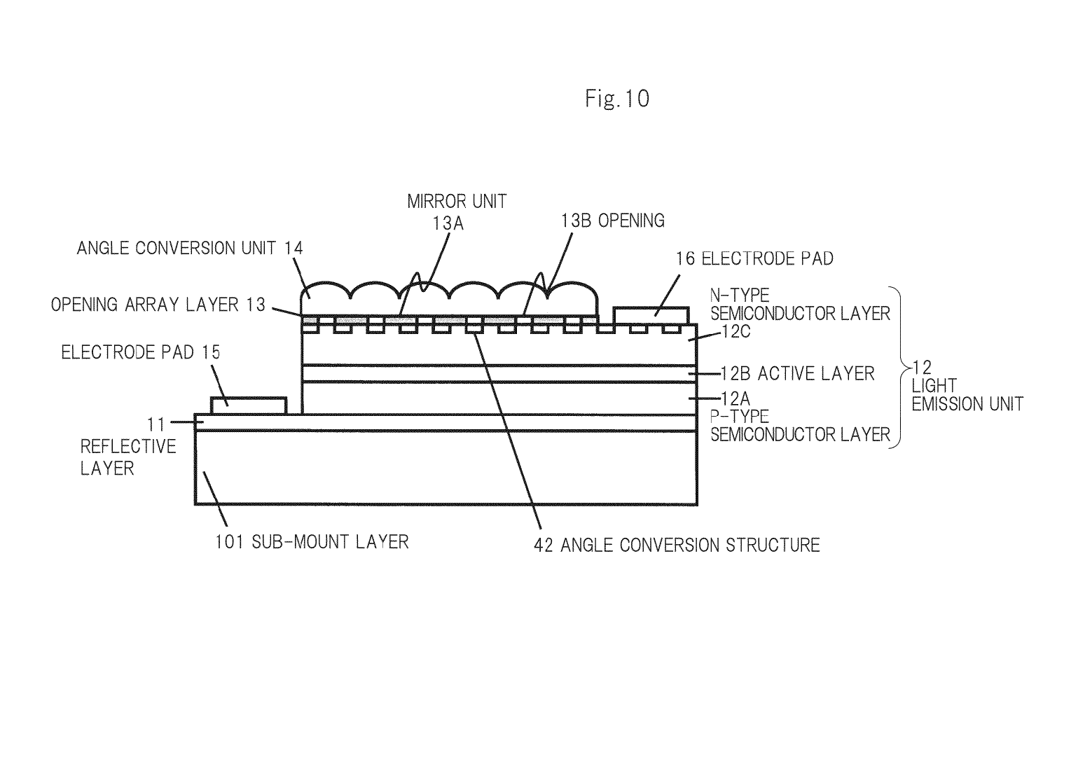

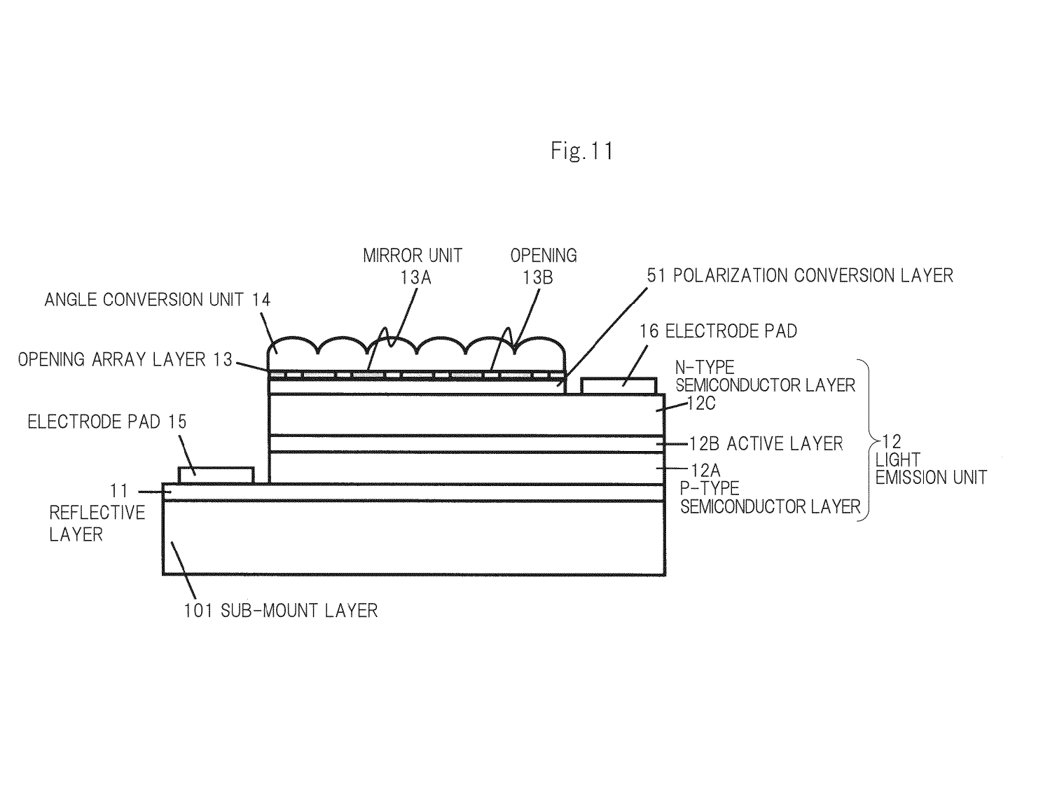

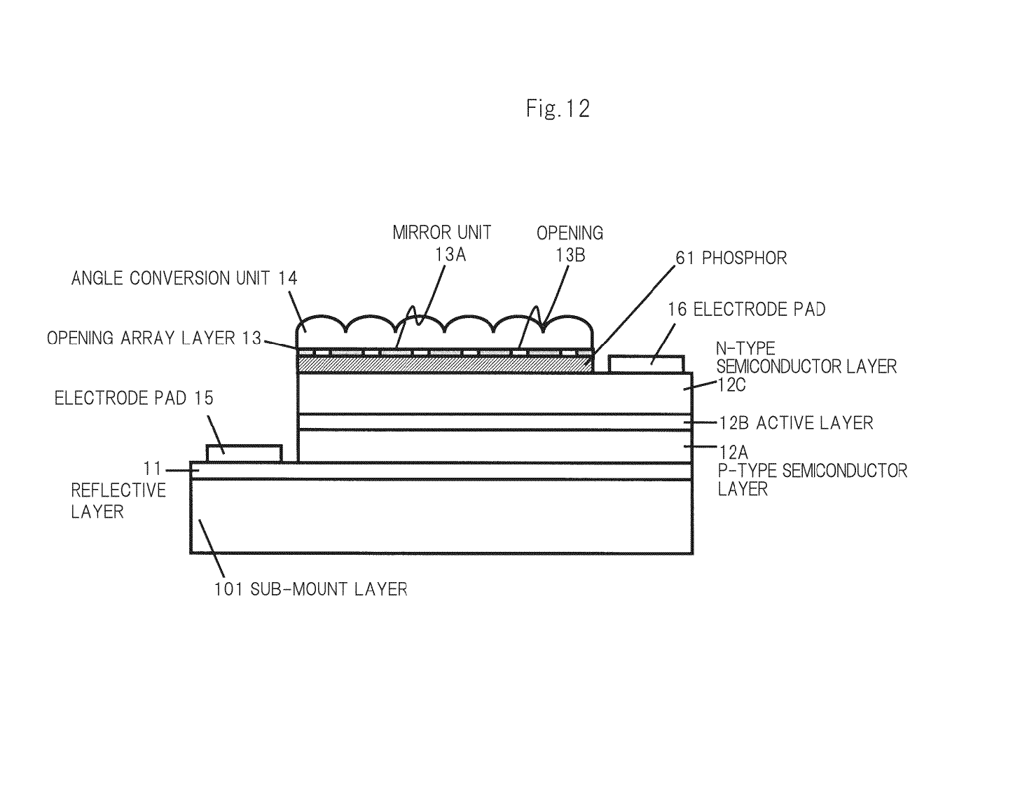

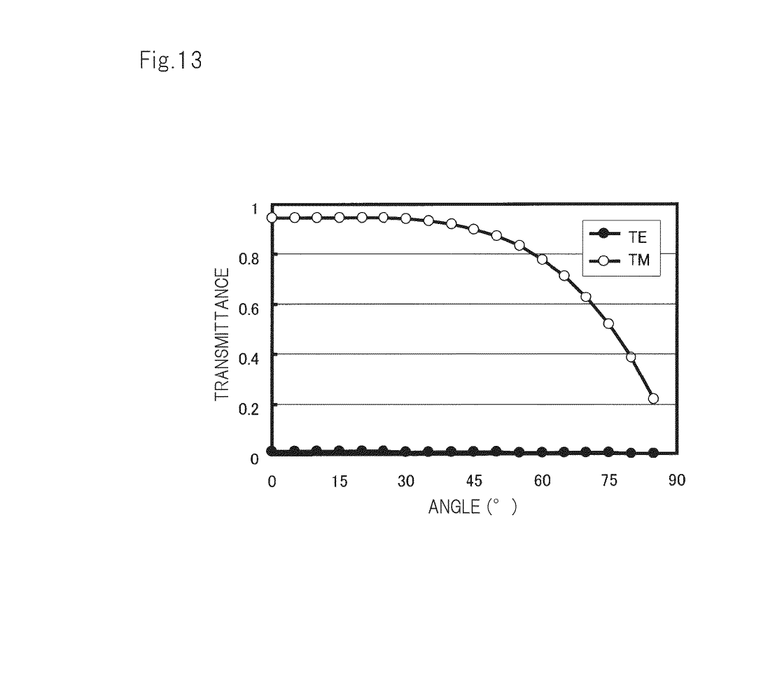

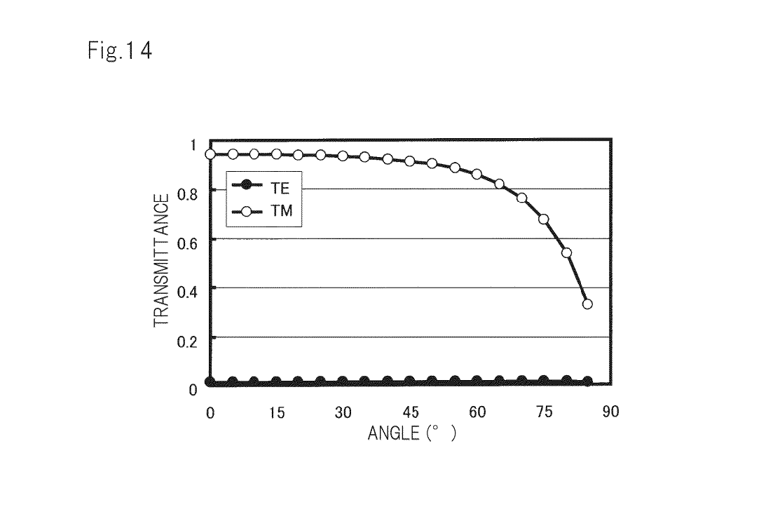

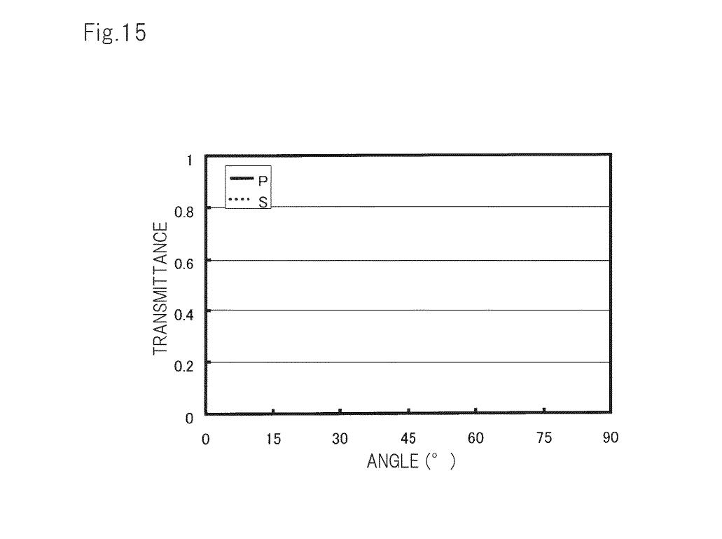

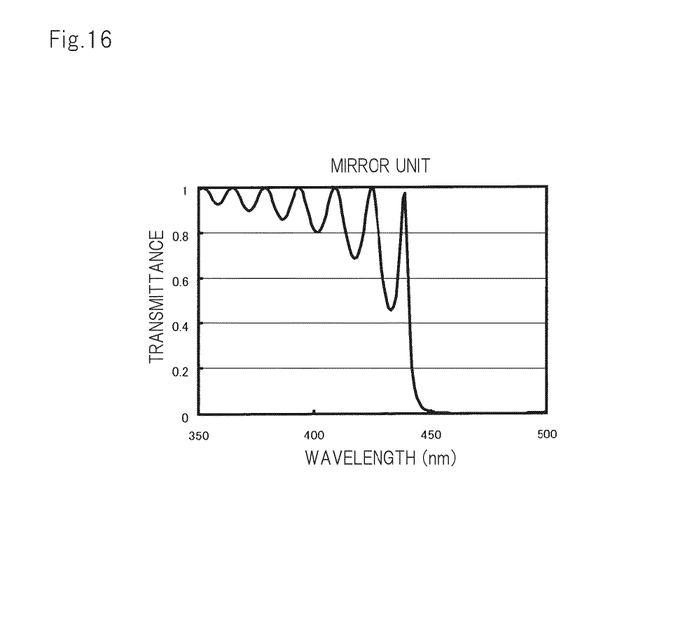

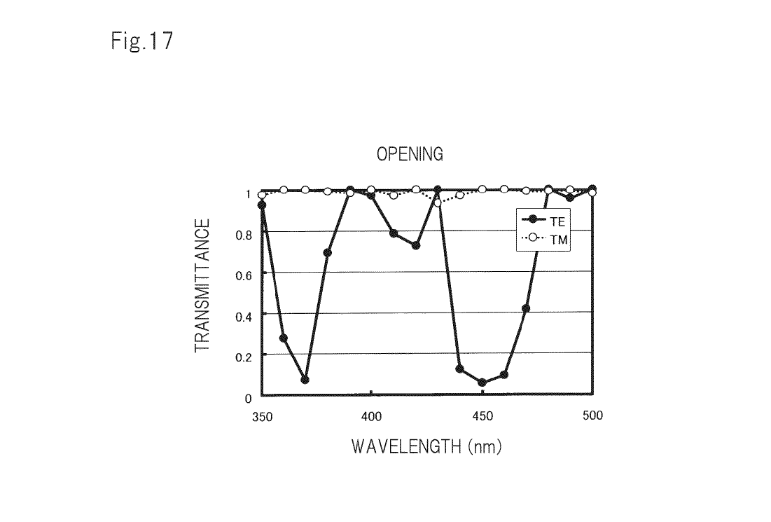

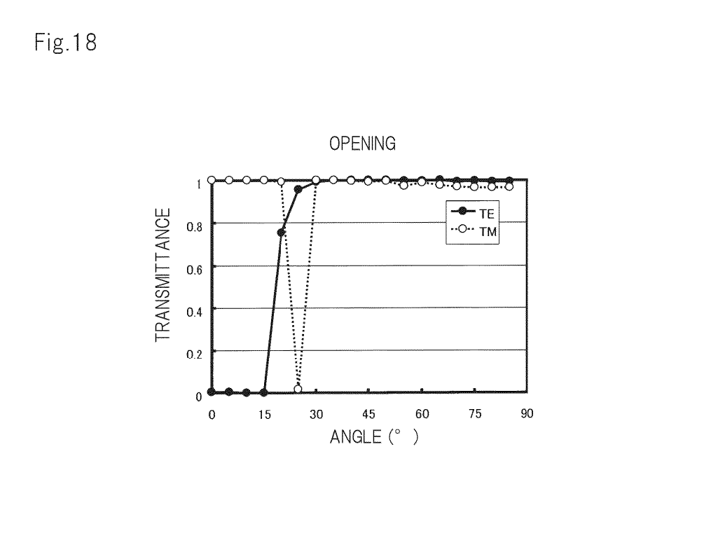

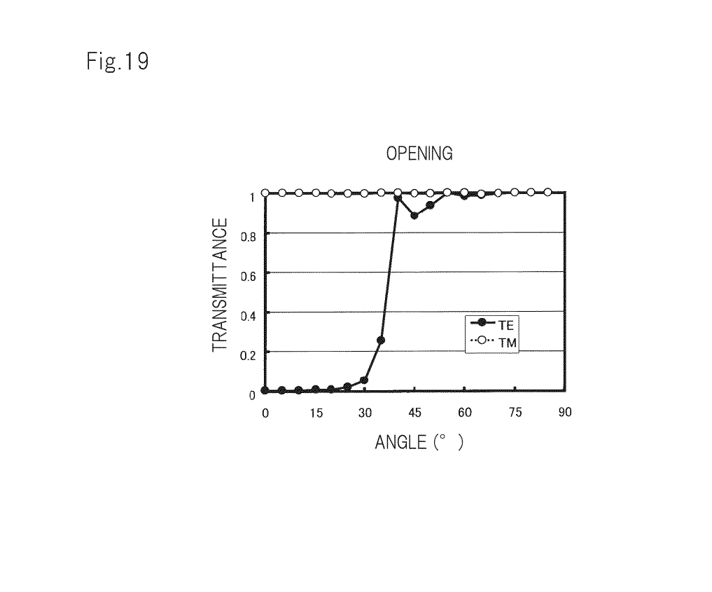

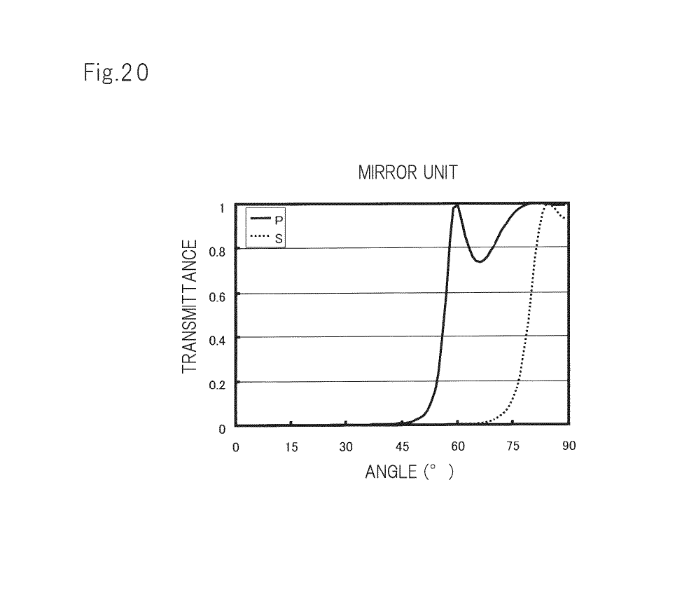

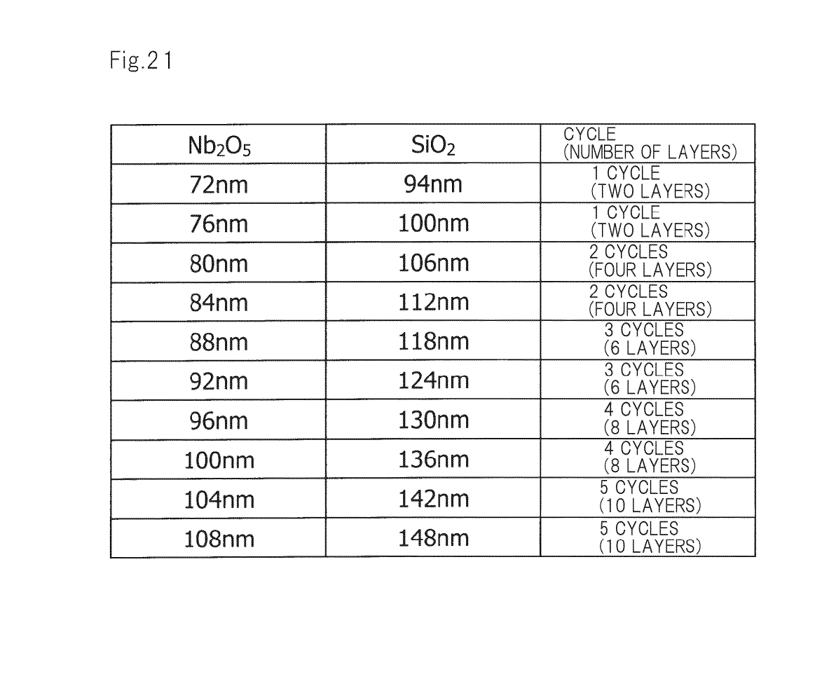

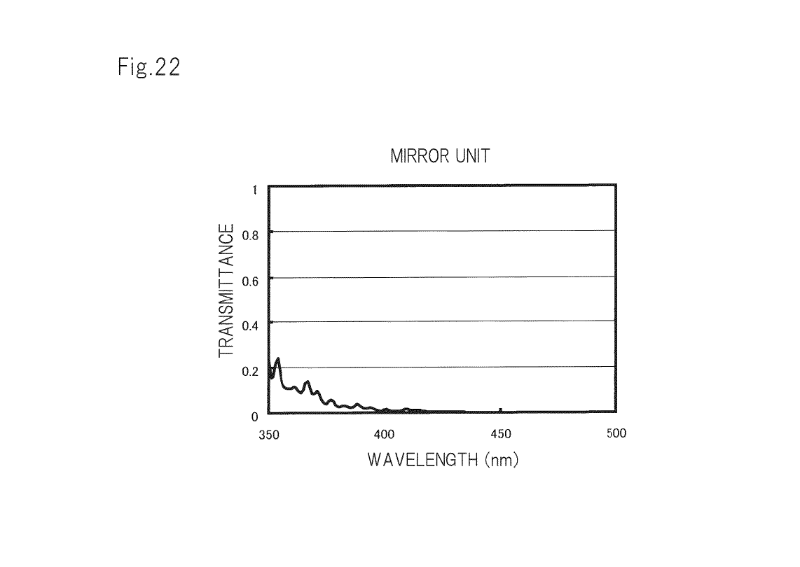

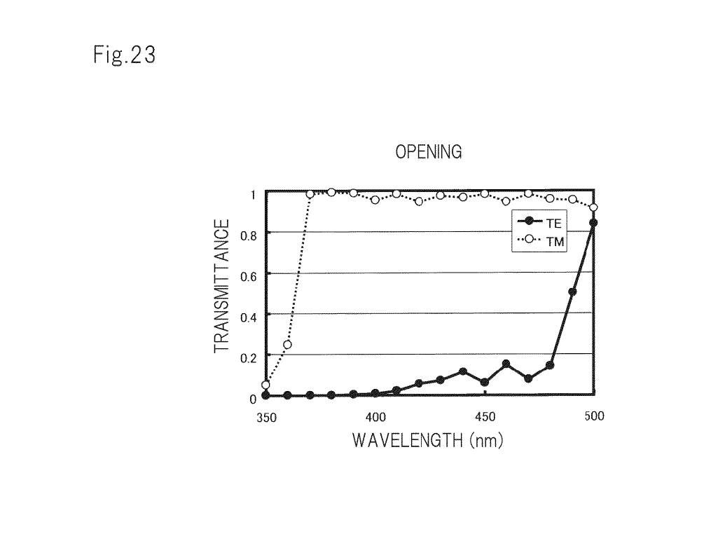

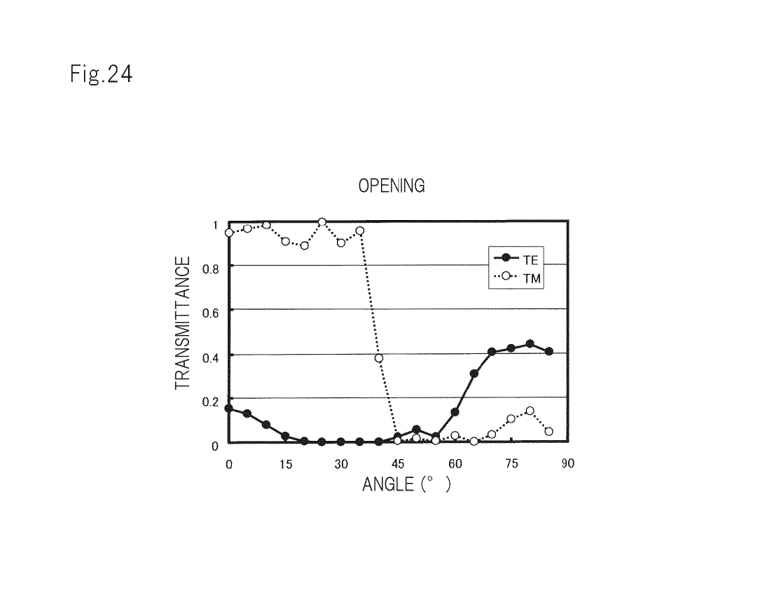

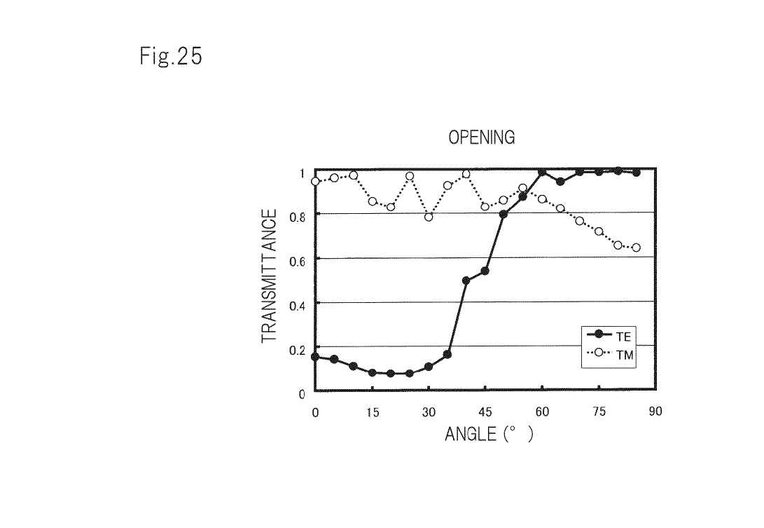

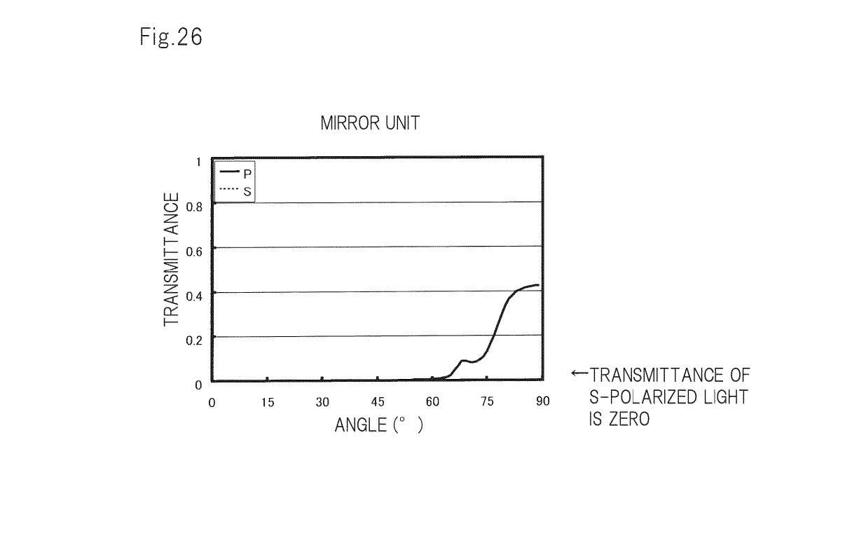

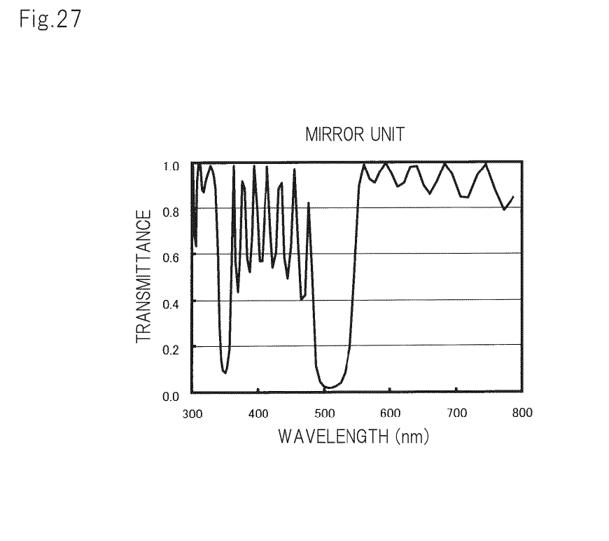

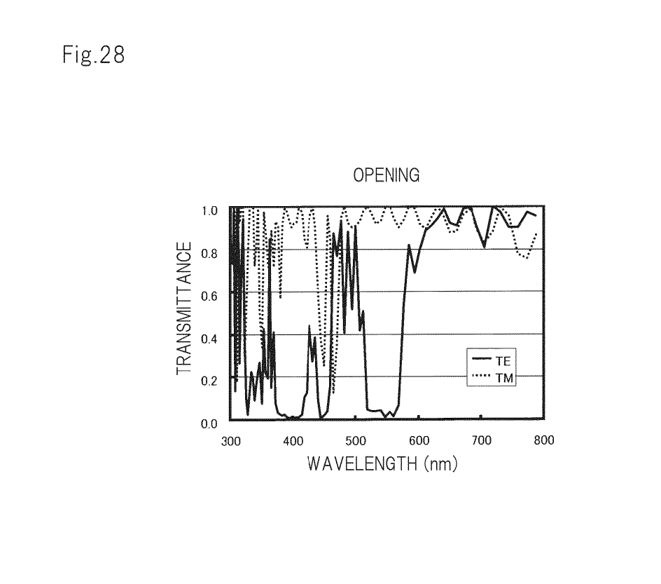

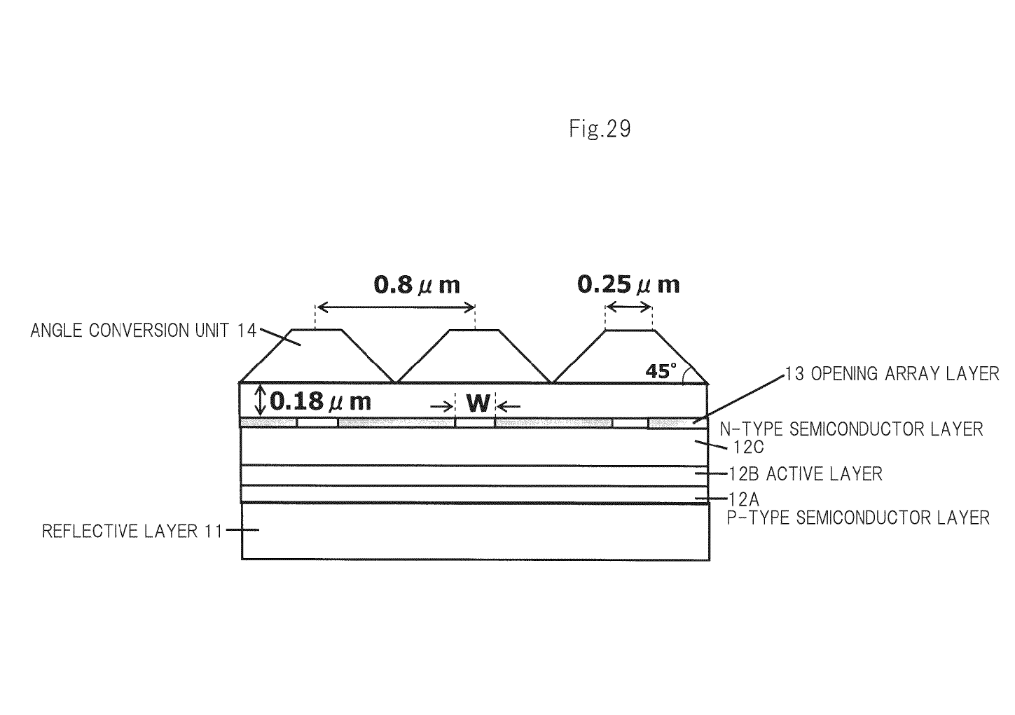

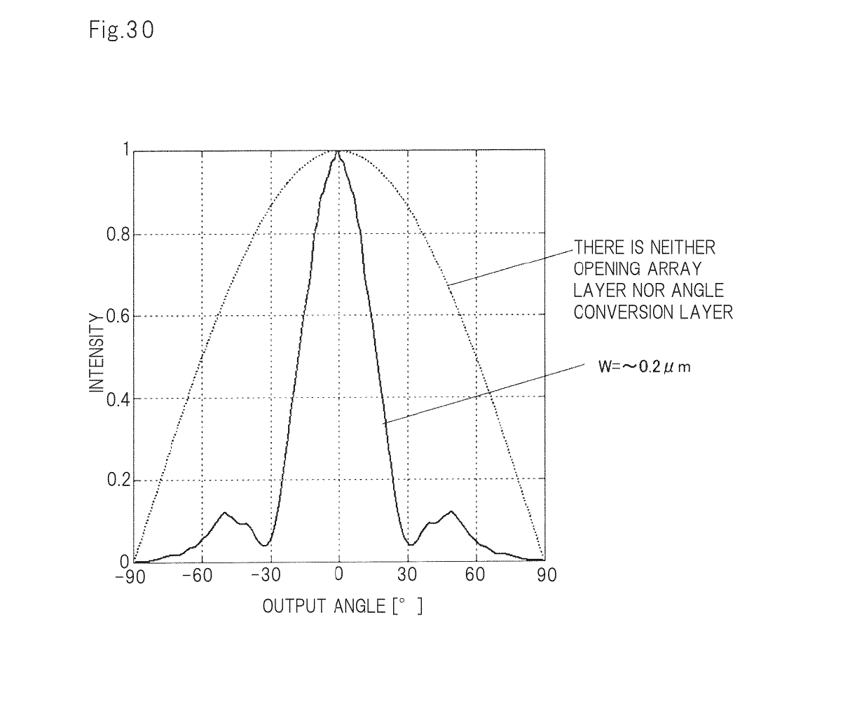

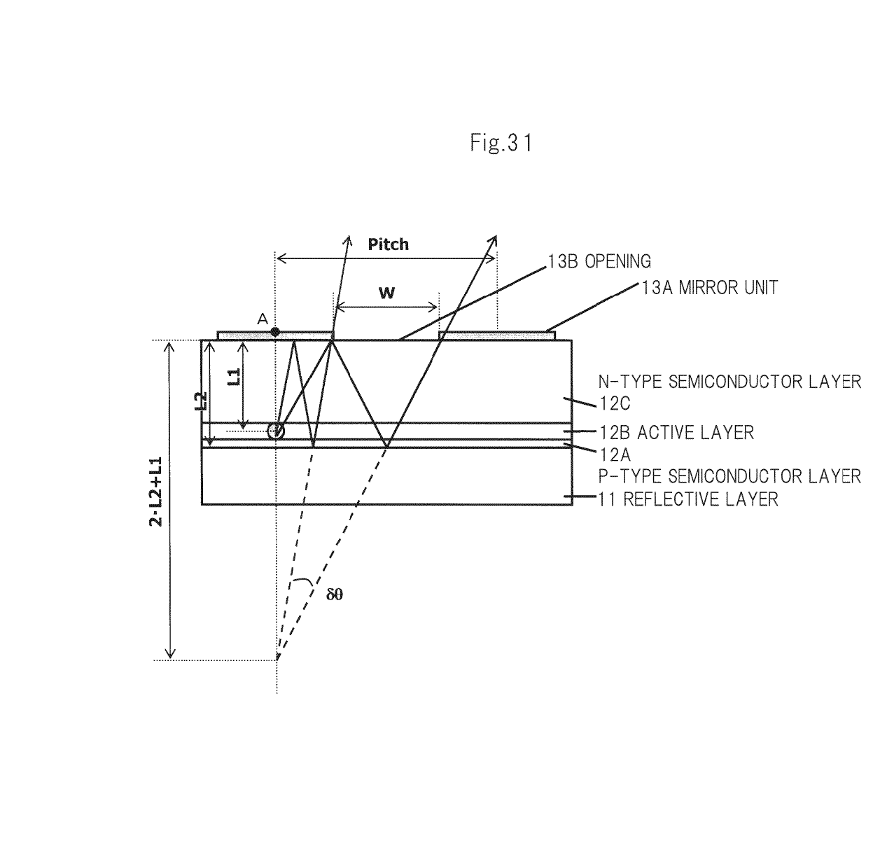

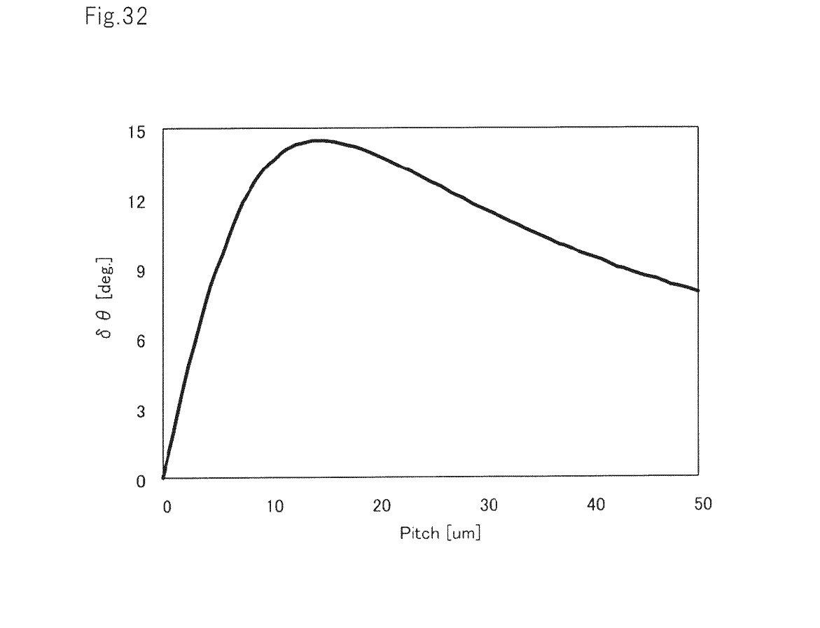

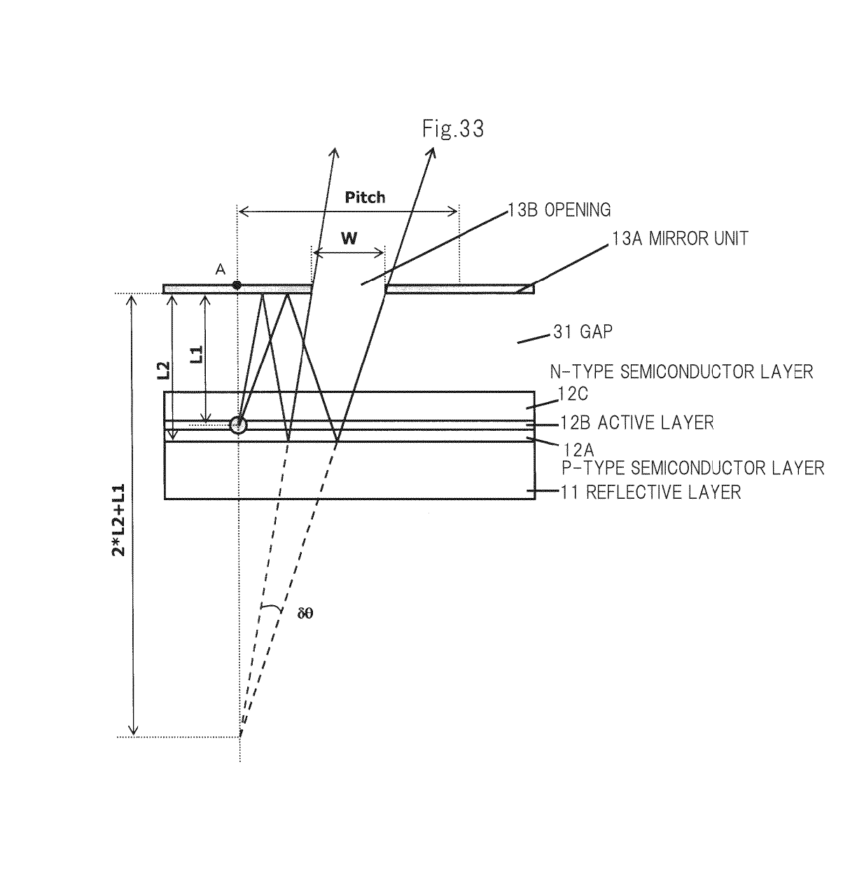

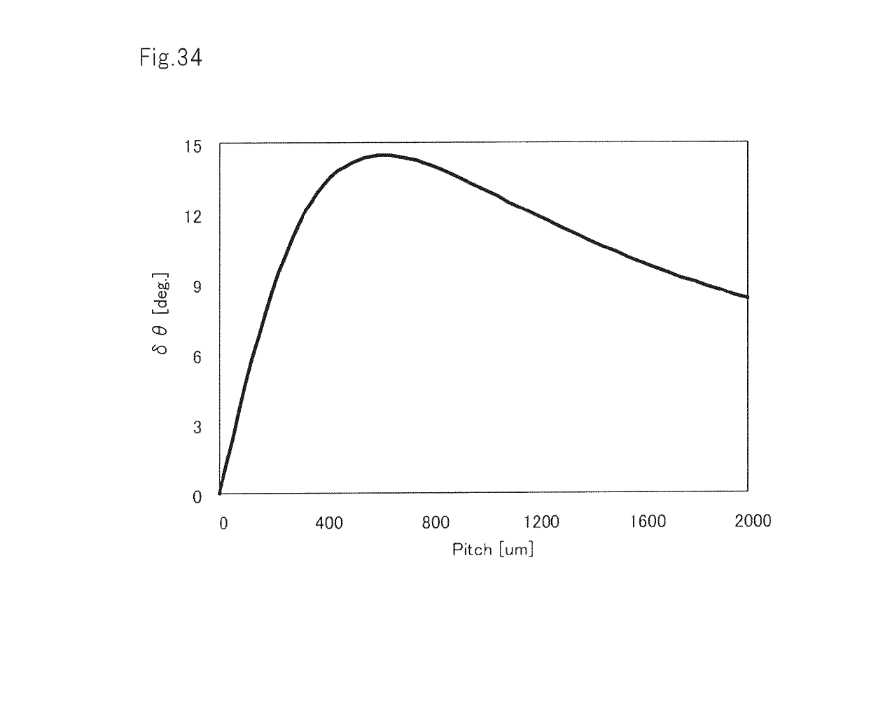

### BRIEF DESCRIPTION OF DRAWINGS

[FIG. 1] A block diagram showing the configuration of an image display device according to the first exemplary embodiment of the present invention.

[FIG. 2] A sectional view schematically showing the configuration of a light source unit according to the first exemplary embodiment of the present invention.

[FIG. 3] A perspective view schematically showing the configuration of an opening array layer.

[FIG. 4] A longitudinal sectional view schematically showing the configuration of the opening array layer.

[FIG. 5] A perspective view schematically showing the configuration of the opening array layer.

[FIG. 6] A longitudinal sectional view schematically showing the configuration of the opening array layer.

[FIG. 7] A sectional view schematically showing the configuration of a light source unit according to the second exemplary embodiment of the present invention.

[FIG. 8] A sectional view schematically showing the configuration of a light source unit according to the third exemplary embodiment of the present invention.

[FIG. 9] A sectional view schematically showing the configuration of a light source unit according to the fourth exemplary embodiment of the present invention.

[FIG. 10] A sectional view schematically showing the configuration of a light source unit according to the fifth exemplary embodiment of the present invention.

[FIG. 11] A sectional view schematically showing the configuration of a light source unit according to the sixth exemplary embodiment of the present invention.

[FIG. 12] A sectional view schematically showing the configuration of a light source unit according to the seventh exemplary embodiment of the present invention.

[FIG. 13] A graph showing an example of incident angle dependence of transmittance in the opening.

[FIG. 14] A graph showing another example of incident angle dependence of transmittance in the opening.

[FIG. 15] A graph showing an example of incident angle dependence of transmittance in the mirror unit.

[FIG. 16] A graph showing an example of wavelength dependence of transmittance in the mirror unit.

[FIG. 17] A graph showing an example of wavelength dependence of transmittance in the opening.

[FIG. 18] A graph showing an example of incident angle dependence of transmittance in the opening.

[FIG. 19] A graph showing another example of incident angle dependence of transmittance in the opening.

[FIG. 20] A graph showing an example of incident angle dependence of transmittance in the mirror unit.

[FIG. 21] A table showing a configuration example of the opening array layer.

[FIG. 22] A graph showing another example of wavelength dependence of transmittance in the mirror unit.

[FIG. 23] A graph showing another example of wavelength dependence of transmittance in the opening.

[FIG. 24] A graph showing another example of incident angle dependence of transmittance in the opening.

[FIG. 25] A graph showing another example of incident angle dependence of transmittance in the opening.

[FIG. 26] A graph showing another example of incident angle dependence of transmittance in the mirror unit.

[FIG. 27] A graph showing another example of wavelength dependence of transmittance in the mirror unit.

[FIG. 28] A graph showing another example of wavelength dependence of transmittance in the opening.

[FIG. 29] A longitudinal sectional view showing an example of a light source unit.

[FIG. 30] A graph showing a relationship between the output angle and the output intensity of light emitted from light source unit 1.

[FIG. 31] An explanatory diagram showing a setting example of a cycle of openings formed in an opening array layer in a light source unit having no gap.

[FIG. 32] A graph showing a relationship between the pitch and the angle width of the opening.

[FIG. 33] An explanatory diagram showing a setting example of a cycle of openings formed in an opening array layer in a light source unit having a gap.

[FIG. 34] A graph showing a relationship between the pitch and the angle width of the opening.

### DESCRIPTION OF EXEMPLARY EMBODIMENTS

Hereinafter, the exemplary embodiments of the present invention will be described with reference to the drawings. In the description, components having similar functions are denoted by similar reference numerals. Description thereof may be omitted.

FIG. 1 is a block diagram showing the configuration of an image display device according to the first exemplary embodiment of the present invention. In FIG. 1, the image display device, which is a projector, includes light source unit 1 and projection unit 2.

Light source unit 1 emits light.

Projection unit 2 is a display unit that displays an image on screen 100 according to a video signal by modulating the light emitted from light source unit 1 according to the video signal to project it to screen 100.

More specifically, projection unit 2 includes spatial light modulation unit 3 and projection optical system 4. Spatial light modulation unit 3 is a spatial light modulation element such as a liquid crystal LV that modulates and outputs the light from light source unit 1 according to the video signal. Projection optical system 4 is an optical system, such as a lens, that projects the light from spatial light modulation unit 3 to screen 100 to display a video on screen 100 according to the video signal.

FIG. 2 is a sectional view schematically showing the configuration of light source unit 1 according to this exemplary embodiment. In light source unit 1, individual real layers are very thin, and the difference in thickness among the layers is very large. It is consequently difficult to draw the layers in accurate scales and ratios. Thus, the layers are schematically shown without being drawn with real ratios.

In FIG. 2, light source unit 1 is mounted on sub-mount layer 101. Light source unit 1 includes reflective layer 11, light emitting unit 12, opening array layer 13, angle conversion unit 14, and electrode pads 15 and 16.

Reflective layer 11 is mounted on sub-mount layer 101. Light emitting unit 12 is formed in a certain area of reflective layer 11, and electrode pad 15 is formed in another area of reflective layer 11. Opening array layer 13 is formed in a certain area of light emitting unit 12, and electrode pad 16 is formed in another area of light emitting unit 12. Angle conversion unit 14 is formed on opening array layer 13. Electrode pads 15 and 16 are electrically connected to an external electrode (not shown).

Light emitting unit 12 includes p-type semiconductor layer 12A, active layer 12B, and n-type semiconductor layer 12C. Active layer 12B is located between p-type semiconductor layer 12A and n-type semiconductor layer 12C. More specifically, p-type semiconductor layer 12A, active layer 12B, and n-type semiconductor layer 12C are stacked in this order on reflective layer 11.

Opening array layer 13 is accordingly located on a side opposite reflective layer 11 with respect to active layer 12B.

Reflective layer 11 reflects the light emitted from light emitting unit 12 to light emitting unit 12 side.

Current is supplied to light emitting unit 12 from an external light source via electrode pads 15 and 16. Light emitting unit 12 emits light according to the current. More specifically, a voltage is applied between p-type semiconductor layer 12A and n-type semiconductor layer 12C from the external light source via electrode pads 15 and 16. When current flows therebetween, light is generated on active layer 12B. In other words, active layer 12B functions as a light emitting layer to o generate light.

Opening array layer 13 includes openings 13F in mirror units 13E that reflect the light emitted from light emitting unit 12. For example, as shown in FIG. 3, openings 13F are arranged in a two-dimensionally cyclical square-lattice shape within the plane of opening array layer 13. Openings 13F can be arranged in a triangle-lattice shape rather than in the square-lattice shape. As compared with the square-lattice shape, the triangle-lattice arrangement can enlarge the area (numerical aperture) of opening 13F with respect to that of opening array layer 13 even while the areas of openings 13F are equal to one another. The shape of opening 13F can be circular or polygonal rather than rectangular shown in FIG. 3.

Opening 13F transmits the polarized light component of a predetermined polarizing direction included in the light from light emitting unit 12, and reflects a polarized light component roughly orthogonal to the predetermined polarizing direction. Hereinafter, the polarized light component of the predetermined polarizing direction is referred to as a polarized wave of a first direction, and the polarized light component roughly orthogonal to the predetermined polarizing direction is referred to as a polarized wave of the second direction.

Opening array layer 13 includes a substrate and a metal film. More specifically, as shown in FIG. 4, it is desirable that the material and the thickness of metal layer 3G in mirror unit 13E of opening array layer 13 be similar to those of metal layer 13G in opening 13F and, in opening 13F, metal films be arranged within a plane in a one-dimensionally cyclical manner. As a material for metal layer 13G, gold, silver, copper, or aluminum is used.

The opening array layer can include a dielectric multilayer film. More specifically, as shown in FIGS. 5 and 6, it is desirable that the material and the thickness of each layer of the dielectric multilayer film in mirror unit 13A of opening array layer 13 be similar to those of each layer of the dielectric multilayer film in opening 13B, and each layer of opening 13B have a one-dimensionally cyclical concave-convex structure within the plane of each layer. In FIG. 6, in opening array layer 13, two dielectric materials, namely, high refractive index layer 13C and low refractive index layer 13D that are different from each other in refractive index, are used. However, three or more types of dielectric materials can be used. The section of the cyclical structure of opening 13B is not limited to a saw-tooth structure shown in FIG. 6. In opening array layer 13 including the dielectric multilayer film, as compared with opening array layer 13 including the metal film, the absorptivity of light incident on mirror unit 13A or opening 13B is low. Thus, the reflectance of mirror unit 13A, the reflectance of opening 13B with respect to the polarized wave of the first direction, and the reflectance of opening 13B with respect to the polarized wave of the second direction are high, and the light generated by light emitting unit 12 can be extracted to the outside with high efficiency.

Hereinafter, a case where the dielectric multilayer film is used for opening array layer 13 will be described.

Angle conversion unit 14 is also referred to as a direction conversion unit. Angle conversion unit 14 converts the output angle (traveling direction) of the light (polarized wave of first direction) transmitted through opening 13B, and improves the directivity of the transmitted light to output it.

More specifically, angle conversion unit 14 includes a lens array where a plurality of lenses corresponding to respective openings 13B are arranged side by side. Opening 13B is located in the focal position of its corresponding lens. Each lens improves the directivity of the light transmitted through its corresponding opening 13B. For the lens array, for example, a microlens array of a several-micron period used for a charge coupled device (CCD) image sensor or a complementary metal oxide semiconductor (CMOS) image sensor can be used.

When the size of opening 13B is equal to or lower than a certain level, the transmitted light from opening 13B can be regarded as light from a point light source. Thus, by using the lens array, the directivity of the transmitted light can be improved.

Hereinafter, the operation of light source unit 1 will be described.

When a voltage is applied between p-type semiconductor layer 12A and n-type semiconductor layer 12C from the external electrode via electrode pads 15 and 16, and current flows therebetween, light is generated on active layer 12B. The light generated on active layer 12B includes components of various directions. The light generated on active layer 12B is unpolarized light.

A part of the light generated on active layer 12B is output toward opening array layer 13. The light incident on mirror unit 13A of opening array layer 13 is reflected toward reflective layer 11. The polarized wave of the first direction (e.g., transverse magnetic wave (TM wave)) incident on opening 13B of opening array layer 13 is transmitted, while the polarized wave of the second direction (e.g., transverse electric wave (TE wave)) is reflected toward reflective layer 11. In this case, the groove direction (Y axis direction shown in FIG. 5) of the concave-convex structure formed in opening 13B functioning as a polarizer is an optical axis, a polarized wave including a polarized light component in a direction (X axis direction shown in FIG. 5) vertical to the optical axis is a TM wave, and a polarized wave including a polarized light component in a direction parallel to the optical axis is a TE wave.

The other part of the light generated on active layer 12B and the light reflected by opening array layer 13 are reflected by reflective layer 11 to enter opening array layer 13.

While the light is repeatedly reflected between reflective layer 11 and opening array layer 13, the polarizing direction and an incident position to opening array layer 13 change, and the light finally passes through opening 13B.

The light transmitted through opening 13B has become polarized light (polarized wave of first direction). This transmitted light is improved for directivity by angle conversion unit 14 to exit.

As described above, according to this exemplary embodiment, active layer 12B generates light. Reflective layer 11 reflects the light from active layer 12B. Opening array layer 13 is located on the side opposite reflective layer 11 with respect to active layer 12B. Opening array layer 13 includes mirror unit 13A that reflects the light from active layer 12B, and opening 13B that transmits the polarized light component of the predetermined polarizing direction included in the light, and reflects the polarized light component orthogonal to the predetermined polarizing direction. Angle conversion unit 14 converts the traveling direction of the light transmitted through opening 13B to output it.

In this case, the polarized light component of the predetermined polarizing direction is transmitted from opening 13B, and the light is output after its traveling direction is converted.

Thus, since only the light form opening 13B is output, thus reducing the etendue of the light output from opening array layer 13, the directivity of the light can be improved by angle conversion unit 14. Since only the light of the predetermined polarizing direction is output from opening 13B, light source unit 1 can emit polarized light. As a result, polarized light having high directivity can be output.

Further, the function in which the opening is used to reduce the etendue of the light and the function in which the polarizer emits polarized light can be realized by one element (opening 13B). Thus, light source unit 1 can be reduced in size and cost.

Next, a second exemplary embodiment will be described.

FIG. 7 is a sectional view schematically showing the configuration of a light source unit according to the second exemplary embodiment of the present invention. The light source unit shown in FIG. 7 is different from the light source unit shown in FIG. 2 in that angle conversion unit 24 is included in place of angle conversion unit 14.

Angle conversion unit 24 is also referred to as a direction conversion unit. As in the case of angle conversion unit 14, angle conversion unit 24 converts the output angle (traveling direction) of light transmitted through opening 13B, and improves the directivity of the transmitted light to output it.

Different from angle conversion unit 14, angle conversion unit 24 includes a tapered cylindrical array where a plurality of tapered cylinders corresponding to respective openings 13B are arranged side by side. Opening 13B is located on a straight line passing through the center of its corresponding tapered cylinder. Each tapered cylinder improves the directivity of the light transmitted through its corresponding opening 13B. The tapered cylinder, in which the circles of an upper surface and a lower surface have different sizes, includes a taper on its side face.

This exemplary embodiment provides the same effects as those of the first exemplary embodiment. Angle conversion unit 24 is created more easily than angle conversion unit 14 that includes the lenses. This provides the effect of creating a light source unit more easily.

Next, a third exemplary embodiment will be described.

FIG. 8 is a sectional view schematically showing the configuration of a light source unit according to the third exemplary embodiment of the present invention. The light source unit shown in FIG. 8 is different from the light source unit shown in FIG. 2 in that gap 31 is formed between light emitting element 12 and opening array layer 13.

Even when gap 31 is formed, opening array layer 13 and angle conversion unit 14 function as in the case of the first exemplary embodiment. Accordingly, the light source unit shown in FIG. 8 comprises functions as in the case of the first exemplary embodiment.

This exemplary embodiment provides the same effects as those of the first exemplary embodiment. Opening array layer 13 and angle conversion unit 14 do not need to be integrally formed with the other layers. Thus, light source unit 1 can be created more easily.

Next, a fourth exemplary embodiment will be described.

FIG. 9 is a sectional view schematically showing the configuration of a light source unit according to the fourth exemplary embodiment of the present invention. The light source unit shown in FIG. 9 is different from the light source unit shown in FIG. 2 in that angle conversion structure 41 for converting the reflection direction of light is formed in the surface of reflective layer 11.

Angle conversion structure 41, which is formed into, for example, a one-dimensional micro concave-convex structure including a mirror surface, a two-dimensional concave-convex structure, or a rough surface structure, converts the reflection direction of the light by diffusely-reflecting the light from active layer 12B side.

This exemplary embodiment provides the same effects as those of the first exemplary embodiment. For example, the exemplary embodiment enables reduction of the number of reflecting times of light between reflective layer 11 and opening array layer 13, the light having been generated in a position directly below mirror unit 13A in active layer 12B and entered roughly vertically to reflective layer 11. As a result, the attenuation of the light caused by reflection can be reduced.

Next, a fifth exemplary embodiment will be described.

FIG. 10 is a sectional view schematically showing the configuration of a light source unit according to the fifth exemplary embodiment of the present invention. The light source unit shown in FIG. 10 is different from the light source unit shown in FIG. 2 in that angle conversion structure 42 for converting the traveling direction of transmitted light is formed in the surface of n-type semiconductor layer 12C.

Angle conversion structure 42, which is made of, for example, a transparent material having a refractive index that is different from that of n-type semiconductor layer 12C, is formed into a one-dimensional or two-dimensional concave-convex structure or a rough surface structure in the in-plane direction of n-type semiconductor layer 12C. Because of the difference in refractive index between angle conversion structure 42 and n-type semiconductor layer 12C, the light transmitted through angle conversion structure 42 is scattered, refracted, or diffracted to convert the traveling direction of the light.

This exemplary embodiment provides the same effects as those of the first exemplary embodiment. For example, the exemplary embodiment enables reduction of the number of reflecting times of light between reflective layer 11 and opening array layer 13, the light having been generated in a position directly below mirror unit 13A in active layer 12B and entered roughly vertically to reflective layer 11. As a result, the attenuation of the light caused by reflection can be reduced.

Next, a sixth exemplary embodiment will be described.

FIG. 11 is a sectional view schematically showing the configuration of a light source unit according to the sixth exemplary embodiment of the present invention. The light source unit shown in FIG. 11 is different from the light source unit shown in FIG. 2 in that polarization conversion layer 51 is further included between light emitting unit 12 and opening array layer 13.

Polarization conversion layer 51 is an element that transmits light and changes the polarization state of the transmitted light. For example, a ¼ wavelength plate or a depolarization plate is used, and polarization conversion layer 51 is made of a transparent material having birefringence.

When the ¼ wavelength plate is used for polarization conversion layer 51, in light output from active layer 12B and transmitted through polarization conversion layer 51 to enter opening 13B, the polarized wave of a first direction is transmitted through opening 13B, and the polarized wave of a second direction is reflected by opening 13B. The polarized wave of the second direction reflected by opening 13B is transmitted through polarization conversion layer 51 to be converted into circular polarized light, reflected by reflective layer 11, and transmitted through polarization conversion layer 51 again to be converted into polarized wave of a first direction. In the first converted polarized wave, light entered into opening 13B is transmitted through opening 13B. Thus, by using the ¼ wavelength plate for polarization conversion layer 51, the number times in which light is reflected in light source unit 1 until the light output from active layer 12B is output from light source unit 1 can be reduced. As a result, the attenuation of the light caused by reflection can be reduced.

When the depolarization plate is used for polarization conversion layer 51, light transmitted through polarization conversion layer 51 becomes unpolarized light. In the light output from active layer 12B and transmitted through polarization conversion layer 51 to enter opening 13B, the polarized wave of the first direction is transmitted through opening 13B, and the polarized wave of the second direction is reflected by opening 13B. The polarized wave of the second direction reflected by opening 13B is transmitted through polarization conversion layer 51 to be converted into unpolarized light, reflected by reflective layer 11, and transmitted through polarization conversion layer 51 again to enter opening array layer 13. In the light entered into opening 13B of opening array layer 13, the polarized wave of the first direction is transmitted through opening 13B, and the polarized wave of the second direction is reflected by opening 13B. Thus, by using the depolarization plate for polarization conversion layer 51, the number of times in which light is reflected in light source unit 1 until the light output from active layer 12B is output from light source unit 1 can be reduced more than in a case where polarization conversion layer 51 is not used. As a result, the attenuation of the light caused by reflection can be reduced.

Next, a seventh exemplary embodiment will be described.

FIG. 12 is a sectional view schematically showing the configuration of a light source unit according to the seventh exemplary embodiment of the present invention. The light source unit shown in FIG. 12 is different from the light source unit shown in FIG. 2 in that phosphor 61 is included between active layer 12B and opening array layer 13.

Phosphor 61 functions as a light emitting layer that absorbs light output from active layer 12B to generate fluorescence, and generates light. Mirror unit 13A of opening array layer 13 reflects the fluorescence generated by phosphor 61. Opening 13B of opening array layer 13 transmits the polarized light component of a predetermined polarizing direction included in the fluorescence generated by phosphor, and reflects a polarized light component roughly orthogonal to the predetermined polarizing direction.

This exemplary embodiment provides, in addition to the same effects as those of the first exemplary embodiment, an effect, namely, the ability to emit light of a desired color.

Next, the configuration example of opening array layer 13 will be described.

Hereinafter, as the configuration example of opening array layer 13, a case where opening array payer 13 is formed by stacking metal layer 13G made of aluminum on substrate layer 13H made of glass will be described. The thickness of metal layer 13G is 110 nanometers, and the cycle and the duty ratio of metal layer 13F of opening 13F are respectively 140 nanometers and 0.3.

FIG. 13 shows the incident angle dependence of transmittance for incident light (light becoming S-polarized light with respect to TE wave, and P-polarized light with respect to TM wave) rotated within a plane (within XZ plane in FIG. 3) vertical to the optical axis (Y axis direction in FIG. 3) of opening 13F. FIG. 14 shows the incident angle dependence of transmittance for incident light (light becoming P-polarized light with respect to TE wave, and S-polarized light with respect to TM wave) rotated within a plane (within YZ plane in FIG. 3) parallel to a straight line (Z axis in FIG. 3) vertical to the optical axis of opening 13F and opening array layer 13. In FIGS. 13 and 14, the wavelength of the incident light is 460 nanometers. In FIGS. 13 and 14, transmittance with respect to the TE wave is indicated by a solid line, and transmittance with respect to the TM wave is indicated by a dotted line.

As shown in FIGS. 13 and 14, opening 13B functions as a polarizer for incident light entered within the incident angle range of 0° to about 60°.

FIG. 15 shows the incident angle dependence of transmittance in mirror unit 13A of opening array layer 13. In FIG. 15, the wavelength of the incident light is 460 nanometers. Mirror unit 13A has no optical axis, and thus there is no distinction between a TE wave and a TM wave. In FIG. 15, transmittance with respect to P-polarized light is indicated by a solid line, and transmittance with respect to S-polarized light is indicated by a dotted line. Transmittances with respect to both polarized lights are zero, and thus both are on axis lines.

As shown in FIG. 15, mirror unit 13E functions as a reflection element for the incident light irrespective of an incident angle.

In opening array 13 using aluminum for metal layer 13G, the incident angle dependencies of the transmittances of mirror unit 13E and opening 13F hardly change within the wavelength range of visible light.

Next, as the configuration example of opening array layer 13, a case where opening array payer 13 is formed by alternately stacking high refractive index layers made of Nb₂O₅ and low refractive index layers made of SiO₂ by ten cycles (20 layers) will be described. The thickness of the high refractive index layer is 100 nanometers, and the thickness of the low refractive index layer is 136 nanometers.

First, the wavelength dependence of transmittance in opening array layer 13 will be described.

FIG. 16 shows the wavelength dependence of transmittance in mirror unit 13A for incident light entered vertically to mirror unit 13A when opening array layer 13 is configured as described above. FIG. 17 shows the wavelength dependence of transmittance in opening 13B for incident light entered vertically to opening 13B when opening array layer 13 is configured as described above.

In FIG. 17, transmittance with respect to the TE wave is indicated by a solid line, and transmittance with respect to the TM wave is indicated by a dotted line. In FIG. 16, mirror unit 13A has no optical axis, and thus there is no distinction between a TE wave and a TM wave.

As shown in FIG. 16, mirror unit 13A functions as a reflection element that reflects the light when the wavelength of the incident light is equal to or more than 440 nanometers. As shown in FIG. 17, opening 13B functions as a polarizer when the wavelength of the incident light is from about 440 to 470 nanometers. In other words, opening 13B reflects the light of the TE wave, and transmits the light of the TM wave.

Next, the incident angle dependence of transmittance in opening array layer 13 will be described.

FIG. 18 shows the incident angle dependence of transmittance for incident light (light becoming S-polarized wave with respect to TE wave, and P-polarized wave with respect to TM wave) rotated within a plane (within XZ plane in FIG. 5) vertical to the optical axis (Y axis direction in FIG. 5) of opening 13B. FIG. 19 shows the incident angle dependence of transmittance for incident light (light becoming P-polarized light with respect to TE wave, and S-polarized light with respect to TM wave) rotated within a plane (within YZ plane in FIG. 5) parallel to a straight line (Z axis in FIG. 5) vertical to the optical axis of opening 13B and opening array layer 13. In FIGS. 18 and 19, the wavelength of the incident light is 460 nanometers. In FIGS. 18 and 19, transmittance with respect to the TE wave is indicated by a solid line, and transmittance with respect to the TM wave is indicated by a dotted line.

As shown in FIGS. 18 and 19, opening 13B functions as a polarizer for incident light entered within the incident angle range of 0° to 15°.

FIG. 20 shows the incident angle dependence of transmittance in mirror unit 13A of opening array layer 13. In FIG. 20, the wavelength of the incident light is 460 nanometers. Mirror unit 13A has no optical axis, and thus there is no distinction between a TE wave and a TM wave. In FIG. 20, transmittance with respect to P-polarized light is indicated by a solid line, and transmittance with respect to S-polarized light is indicated by a dotted line.

As shown in FIG. 20, mirror unit 13A functions as a reflection element for the incident light entered within the incident angle range of 0° to 45°.

The incident angle dependencies and the wavelength dependencies of the transmittances of mirror unit 13A and opening 13B change according to the configuration of opening array layer 13. Accordingly, by appropriately adjusting the configuration of opening array layer 13, the ranges of the wavelengths and the incident angles of the incident light where mirror unit 13A functions as a reflection element and opening 13B functions as a polarizer can be widened more than in the aforementioned configuration example.

FIG. 21 shows another example of opening array layer 13. In the case of opening array layer 13 shown in FIG. 21, the incident angle dependencies and the wavelength dependencies of the transmittances of mirror unit 13A and opening 13B are as shown in FIGS. 22 to 26. Specifically, FIG. 22 shows the wavelength dependence of transmittance in mirror unit 13A for incident light entered vertically to mirror unit 13A. FIG. 23 shows the wavelength dependence of transmittance in opening 13B for incident light entered vertically to opening 13. FIG. 24 shows the incident angle dependence of transmittance for incident light rotated within a plane vertical to the optical axis of opening 13B. FIG. 25 shows the incident angle dependence of transmittance for incident light rotated within a plane parallel to a straight line vertical to the optical axis of opening 13B and opening array layer 13. FIG. 26 shows the wavelength dependence of transmittance in mirror unit 13A for incident light. In FIGS. 24 to 26, the wavelength of the incident light is 460 nanometers. In FIGS. 23 to 25, transmittance with respect to the TE wave is indicated by a solid line, and transmittance with respect to the TM wave is indicated by a dotted line. Further, in FIG. 26, transmittance with respect to P-polarized light is indicated by a solid line, and transmittance with respect to S-polarized light is indicated by a dotted line. Transmittance with respect to S-polarized light is zero, and thus the S-polarized light is on an axis line.

As shown in FIGS. 22 and 23, for the incident light entered vertically to opening array layer 13, when the wavelength of the incident light is 370 to 480 nanometers, mirror unit 13A functions as a reflection element, and opening 13B functions as a polarizer. As shown in FIGS. 24 to 26, mirror unit 13A functions as a reflection element for the incident light within the incident angle range of 0° to 65°, and opening 13B functions as a polarizer for the incident light within the incident angle range of 0° to 30°.

Accordingly, in opening array layer 13 configured as shown in FIG. 21, the ranges of the wavelengths and the incident angles of the incident light where mirror unit 13A functions as a reflection element and opening 13B functions as a polarizer are wider.

By appropriately adjusting the configuration of opening array layer 13, the wavelength of the light transmitted through opening array layer 13 can be adjusted.

For example, when opening array payer 13 is formed by alternately stacking high refractive index layers made of Nb₂O₅ and low refractive index layers made of SiO₂ by eight cycles (16 layers), the thickness of each high refractive index layer is 136 nanometers, and the thickness of each low refractive index layer is 136 nanometers, the wavelength dependence of transmittance in mirror unit 13A for incident light entered vertically to mirror unit 13A is as shown in FIG. 27, and the wavelength dependence of transmittance in opening 13B for incident light entered vertically to opening 13 is as shown in FIG. 28.

As shown in FIGS. 27 and 28, when the wavelength of incident light is 510 to 540 nanometers, mirror unit 13A functions as a reflection element, and opening 13B functions as a polarizer.

Next, the example of the directivity of the light source unit will be described. FIG. 29 is a longitudinal sectional view showing the example of the light source unit. In

FIG. 29, the light source unit includes angle conversion unit 24 shown in FIG. 7.

In FIG. 29, openings 13B are arranged side by side in a cyclical manner, and a center interval between adjacent openings 3B is 0.8 micrometers. In angle conversion unit 24, a tapered cylindrical array is formed on a layer having a uniform thickness (0.18 micrometers) that covers opening array payer 13. Each tapered cylinder of the tapered cylindrical array is formed by matching the center on its corresponding opening. The tapered angle of each tapered cylinder is 45°, and the diameter of the upper surface circle of each tapered cylinder is 0.25 micrometers. Opening 13B has a width W.

Extraction efficiency that is a ratio of the amount of light output from opening 13 to the amount of light generated from light emitting unit 12 is higher as the width W of opening 13B is larger. This is because as the width of opening 13B is larger, the number of times in which light is reflected on reflective layer 11 and opening array layer 13 can be further reduced. On the other hand, as the width W of opening 13B is smaller, the directivity of the light emitted from light source unit 1 can be improved in angle conversion unit 24. In other words, there is a trade-off relationship between extraction efficiency and directivity.

In the light source unit shown in FIG. 29, when the width W of opening 13B is set to about 0.2 micrometers, a relationship between the output angle and the output intensity of the light emitted from light source unit 1 is as shown in FIG. 30. FIG. 30 also shows a relationship between the output angle and the output intensity when opening array layer 13 and angle conversion layer 14 are not present. A vertical axis shown in FIG. 30 is standardized with output intensity toward 0°. Opening array layer 13 has the same configuration as that described above, and the wavelength of light generated from light emitting unit 12 is 445 nanometers.

When opening array layer 13 and angle conversion layer 14 are not present, emission intensity distribution is a lambert distribution. It can be understood from FIG. 30 that when opening array layer 13 is present, the output light concentrates within ±30°, and the directivity of the output light is higher than when opening array layer 13 and angle conversion layer 14 are not present.

Next, a setting example of the cycle and the size of opening 13B formed in opening array layer 13 will be described.

It is desirable for the light generated from active layer 12B to directly enter opening 13B without being reflected by reflective layer 11. In reality, however, there is light to be reflected. When the number of times in which light is reflected increases, the light is absorbed by reflective layer 11 to be attenuated, consequently reducing the emission efficiency of light source unit 1. Hereinafter, the configuration example of opening array layer 13 that is suitably used when the light is reflected once by reflective layer 11 to enter opening 13B will be described.

FIG. 31 is an explanatory diagram showing a setting example of a cycle of openings 13B formed in opening array layer 13, which is suitably used when the light is reflected once by reflective layer 11 to enter opening 13B. FIG. 31 shows a light source unit having no gap between light emitting unit 12 and opening array layer 13.

A distance from the center of active layer 12B to opening array layer 13 is L1, the distance from the surface of reflective layer 11 to opening array layer 13 is L2, the cycle of opening 13B is P (pitch), and the size of opening 13B is W. The position of a light emitting point within the plane of active layer 12 is the center A of the forming portion of mirror unit 13 where it is most difficult for the light to be reflected only once to exit.

As shown in FIG. 31, in the light generated from the light emitting point and reflected once to exit, the amount of light reflected once to exit becomes larger as the width δθ of an angle formed between light output at a shortest distance and light output at a longest distance becomes larger. The intersection point of each output light is located at a distance of 2×L2+L1 from the center A of mirror unit 13A.

FIG. 32 shows a relationship of the pitch P and the angle width 60 of opening 13B when L1=2.3 μm and L2=2.4 μm are set and the ratio W/P of the width W of opening 13B to the cycle P is set to 0.25. It can be understood from FIG. 32 that the pitch P needs to be set to about 14 micrometers to achieve a maximum angle width δθ (about 14.5°).

FIG. 33 is an explanatory diagram showing a setting example of a cycle of openings 13B formed in opening array layer 13, which is suitably used when the light is reflected once by reflective layer 11 to enter opening 13B. FIG. 31 shows a light source unit having gap 31 between light emitting unit 12 and opening array layer 13.

In FIG. 33, as in the case shown in FIG. 31, the distance from the center of active layer 12B to opening array layer 13 is L1, the distance from the surface of reflective layer 11 to opening array layer 13 is L2, the cycle of opening 13B is P (pitch), and the size of opening 13B is W. The position of the light emitting point within the plane of active layer 12 is the center A of the forming portion of mirror unit 13 where it is most difficult for the light to be reflected only once to exit.

As shown in FIG. 32, in the light generated from the light emitting point and reflected once to exit, the amount of light reflected once to exit become larger as the width 60 of an angle formed between light output at a shortest distance and light output at a longest distance becomes larger. The intersection point of each output light is located a t a distance of 2×L2+L1 from the center A of mirror unit 13A.

FIG. 34 shows a relationship of the pitch P and the angle width 60 of opening 13B when L1=99.9 μm and L2=100 μm are set and the ratio W/P of the width W of opening 13B to the cycle P is set to 0.25. It can be understood from FIG. 32 that the pitch P needs to be set to about 600 micrometers to achieve a maximum angle width δθ (about 14.5°).

The present invention has been described referring to the exemplary embodiments. However, the present invention is not limited to the exemplary embodiments. Various changes understandable to those skilled in the art can be made to the configuration and the specifics of the present invention.

The image display device can be a rear projector that includes screen 100 and projects light from the rear surface side of screen 100, or an image display device other than a projector.

This application claims priority from Japanese Patent Application No. 2010-117241 filed May 21, 2010, which is hereby incorporated by reference herein in its entirety.

What is claimed is:

1. A light source unit comprising:
a light emitting layer that generates light;
a reflective layer that reflects the light generated from the light emitting layer;
an opening array layer that is formed on a side opposite the reflective layer with respect to the light emitting layer and that includes a mirror unit configured to reflect the light generated from the light emitting layer, and a plurality of openings configured to transmit a polarized light component of a predetermined polarizing direction included in the light generated from the light emitting layer and to reflect a polarized light component orthogonal to the predetermined polarizing direction; and
a direction conversion unit that converts the traveling direction of the light transmitted through the openings.

2. The light source unit according to claim 1, wherein:
the direction conversion unit is a lens array that includes a plurality of lenses corresponding to the plurality of openings; and
each of the plurality of openings is disposed in a focal position of a corresponding lens.

3. The light source unit according to claim 1, wherein:
the direction conversion unit is a tapered cylindrical array that includes a plurality of tapered cylinders corresponding to the plurality of openings; and
each of the plurality of openings is disposed on a straight line passing through a center of a corresponding tapered cylinder.

4. The light source unit according to claim 1, wherein:
the opening array layer includes a substrate layer and a metal layer; and
materials and thicknesses of the substrate layer and the metal layer in the mirror unit are similar to those of the substrate layer and the metal layer in the opening.

5. The light source unit according to claim 4, wherein in the metal layer in the opening, metal films are cyclically arranged in a one-dimensional direction within a plane of the metal layer.

6. The light source unit according to claim 1, wherein:
the opening array layer includes a dielectric multilayer film; and
a material and a thickness of each layer of the dielectric multilayer film in the mirror unit are similar to those of each layer of the dielectric multilayer film in the opening.

7. The light source unit according to claim 6, wherein each layer of the dielectric multilayer film in the opening has a one-dimensionally cyclical concave-convex structure within a plane of each layer.

8. The light source unit according to claim 1, further comprising a gap formed between the opening array layer and the light emitting layer.

9. The light source unit according to claim 1, further comprising an angle conversion structure formed between the opening array layer and the reflective layer to change a traveling direction of the light.

10. The light source unit according to claim 1, further comprising a polarization conversion layer formed between the opening array layer and the reflective layer to transmit the light and change a polarized state of the transmitted light.

11. The light source unit according to claim 10, wherein the polarization conversion layer is a wavelength plate.

12. The light source unit according to claim 10, wherein the polarization conversion layer is a depolarization plate.

13. The light source unit according to claim 1, wherein the light emitting layer is a phosphor.

14. An image display device comprising:
the light source device according to claim 1; and
a display unit that modulates light emitted from the light source unit according to a video signal and displays an image according to the video signal.
